(19) United States
(12) Patent Application Publication
(10) Pub. No.: US 2017/0293556 A1
(43) Pub. Date: Oct. 12, 2017

(54) READ DISCARDS IN A PROCESSOR SYSTEM WITH WRITE-BACK CACHES

(71) Applicant: Imagination Technologies Limited, Kings Langley (GB)

(72) Inventor: Ranjit J. Rozario, San Jose, CA (US)

(21) Appl. No.: 15/093,404

(22) Filed: Apr. 7, 2016

(51) Int. Cl. G06F 12/0804; G06F 12/0817; G06F 12/0897; G06F 12/0842; G06F 12/0864; G06F 12/0811; G06F 12/084

(52) U.S. Cl. CPC G06F 12/0804; G06F 12/0811; G06F 12/0817; G06F 12/084; G06F 12/0842; G06F 12/0864; G06F 12/0897; G06F 2212/6042

(57) ABSTRACT

A system and method provide for a better way of managing a shared memory system. A multiprocessor system includes a first and second CPU, with each CPU having a private L1 cache. The system further includes a level 2 (L2) cache shared between the first CPU and the second CPU, and includes a memory coherency manager (CM) and an I/O device. The second CPU is configured to request ownership of a cache line in the L1 cache of the first CPU that is in a Modified state. Later, upon receiving a read discard command from the I/O device, the second CPU is configured to request the CM update the cache line from a Modified state to a Shared state.

### FIELD OF THE INVENTION

Various configurations of the current invention relate generally to an apparatus, systems, and methods for managing memory systems. More particularly, the apparatus, systems, and methods relate to managing memory systems where multiple processors have their own memory cache. Specifically, the apparatus, systems, and methods provide for managing private caches when read discard and read shared operations are performed.

### BACKGROUND OF THE INVENTION

Current computer systems often have several processors that may be implemented in a single device. These processors may often have their own level one caches (L1) but may share a common level two cache (L2). At times, a processor may write different data to its L1. In a write-back memory scheme, when an L1 is written with new data, it is not immediately written to the L2 cache until there is a need to update the L2 cache. If another process were to read data in the L2 cache corresponding to the same address of data in another processor's L1 that has been changed, it would be reading older, incorrect data. Thus, there needs to be some control in a multiprocessor system to ensure a shared L2 cache is updated when needed.

A coherency manager (CM) may manage the sharing of data within a hierarchical memory. The CM often may implement one of several coherency protocols. One common protocol is the Modified, Exclusive, Shared, and Invalid (MESI) protocol. The MESI protocol marks each cache line as being either in a Modified state, an Exclusive state, a Shared state, or an Invalid state. When a cache line is in the Modified state, it is present only in the current cache and is dirty; it has been modified from the value in main memory (or a shared next level cache). When a modified cache line is later written back to the main memory as instructed by the CM, the line is changed to the Exclusive state. In the Exclusive state, the cache line is present only in the current cache, but is clean; it matches memory (or a shared next level cache). It may be changed to the Shared state at any time in response to a read request. Alternatively, it may be changed to the Modified state when writing to it. When a cache's line is in the Shared state, it may be stored in other caches of the machine and is clean; it matches memory (or a shared next level cache). The Invalid state indicates that this cache line is invalid (unused).

Consider a multiprocessor system that has a first CPU 0 with its own L1 and a second CPU 1 with its own L1, a CM, and an input/output (I/O) device. Because I/O devices often do not cache data they load, they issue read discard commands. When a read command is sent from the I/O device to the CM, the CM will send a read discard command to, for example, CPU 0 because it has a modified L1 cache line. In response, CPU 0 will send the requested four bytes of data from this line back to the CM so that this data may be sent to the I/O device. Because the I/O device does not cache this data, the I/O read request was a read discard command to prevent CPU 0 from updating (writing back) the L2 with the cache line from which the data was read. When reading a block of data, the I/O device will cause another read discard command to be sent to CPU 0 to load the next four bytes. Similarly, CPU 0 again must respond to the next read discard command. Again, the I/O device may generate another read discard for the next four bytes in the L1 cache. Because the I/O device may be reading a block of data, it may cause many read discard commands to be sent to CPU 0 causing CPU 0 to respond to many read discard commands at the expense of performing other useful work. In another scenario, multiple I/O devices may all try to read the same memory location resulting in multiple read discard commands being sent to the CPU. What is needed is a better memory system.

### SUMMARY OF THE INVENTION

One embodiment is a multiprocessor system that provides a better way of managing a shared memory system. The multiprocessor system includes a first and second CPU with each CPU having a private L1 cache. The system further includes a level 2 (L2) cache shared between the first CPU and the second CPU, and includes a memory coherency manager (CM) and an I/O device. The second CPU is configured to request ownership of a cache line in the L1 cache of the first CPU that is in a Modified state. Later, the second CPU is configured to request the CM update the cache line from a Modified state to a Shared state upon receiving a read discard command from the I/O device.

Another configuration is a method wherein a CPU detects a device is reading its private L1 cache using read discard commands, and then the CPU moves that cache line to a Shared state. At times, an I/O device or another device may request blocks of data using read discard commands when the device will not cache the data. In response, a CPU that may be part of a shared memory system, receives a read discard command from a CM. An L1 cache line of the CPU having data requested by the read discard command is then moved from a Modified state to a Shared state and is also written back to an L2 cache. As discussed below, the CPU is now free to perform other useful tasks without needing to respond to future read discard commands to that cache line until the CPU again modifies the cache line. In some configurations, the method may make a determination as to if the CPU desires to not write-back the cache line and keep responding to read discard commands with the cache line in the Modified state. If the CPU does not want to respond to possible multiple read discard commands to a cache line, then it has that line placed in the Shared state; otherwise, it keeps the line in the Modified state.

Another configuration is a method of reducing the pollution in an L1 cache when responding to a memory copy (Memcpy) routine or another loading of a block of memory. The method begins by receiving read shared commands at a CPU where the read shared commands request data in a cache line of a private cache of the CPU. A determination is made if the read shared commands correspond to a Memcpy loop or another block memory read. As discussed below, this determination may be made with block read detection logic that detects a block of data is being read. Alternatively, a special format of the load instructions may be used to indicate to the CPU that it is processing a Memcpy loop. For example, one or more flag bit(s) may be set in a load instruction that the CPU may detect as indicating the instruction corresponds to a Memcpy loop. When a Memcpy loop is detected, the CPU requests a CM issue a read discard command for the rest of the current cache line being accessed to prevent the pollution of the L1 cache. In other embodiments, the CPU itself may decide to change the command to a read discard command to the CM. In some configurations, the method may also request the CM issue a read discard command for the next cache line in the sequence of the Memcpy loop.

### BRIEF DESCRIPTION OF THE DRAWINGS

One or more preferred embodiments that illustrate the best mode(s) are set forth in the drawings and in the following description. The appended claims particularly and distinctly point out and set forth the invention.

The accompanying drawings, which are incorporated in and constitute a part of the specification, illustrate various example methods and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples, one element may be designed as multiple elements or that multiple elements may be designed as one element. In some examples, an element shown as an internal component of another element may be implemented as an external component and vice versa. Furthermore, elements may not be drawn to scale.

FIG. 1 illustrates one configuration of a multiprocessor system with a partially shared memory system.

FIG. 2 illustrates a configuration of a processor and a memory system.

FIG. 3 illustrates an example configuration of a method of a CPU detecting a device is reading its private L1 cache using read discard commands and moving that cache line to a Shared state.

FIG. 4 illustrates an example configuration of a method of reducing the pollution in an L1 cache when responding to a block read or a memory copy (Memcpy) routine.

FIGS. 5A and 5B illustrate an example configuration of a multiprocessor system in which various configurations of the invention may operate.

Similar numbers refer to similar parts throughout the drawings.

### DETAILED DESCRIPTION OF THE DRAWINGS

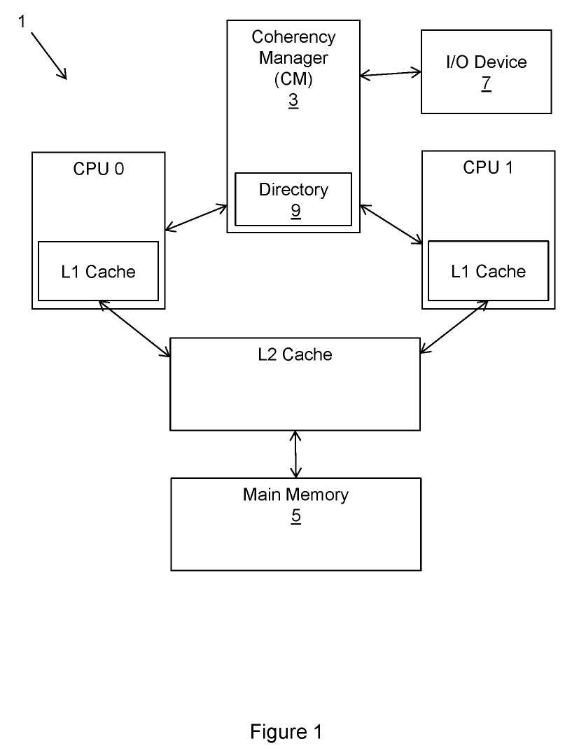

FIG. 1 illustrates one embodiment of a system 1 having an at least partially shared memory system. The system 1 includes two processors (CPU 0 and CPU 1), a coherency manager (CM) 3, a level two (L2) cache, a main memory 5, and an input/output (I/O) device 7. CPU 0 and CPU 1 each have a local level one (L1) cache that are write-back caches that write caches lines to the L2 cache when needed or when instructed to write data to the L2 cache. The L1 caches are private, meaning that each CPU 0-1 solely controls and accesses its L1 cache. CM 3 further includes a directory 9.

In operation, CM 3 uses directory 9 to keep track of which CPU 0-1 has which L2 cache line stored in its L1 cache and what state that cache line is in. CM 3 may additionally keep track of cache lines in the L2 cache and what state those lines are in. In this example embodiment, CM 3 will manage the caches according to a coherency protocol such as the MESI protocol. For example, consider that CPU 1 has a cache line that it loaded from the L2 cache into its L1 cache and then wrote new data to that cache line so that it is now modified. The CM 3 would record in directory 9 that CPU 1 owns that cache line and that it is in the Modified state according to the MESI protocol. In some cache protocols, the L2 does not know that the L1 is in the modified state. It just knows that the line is in one of the exclusive (Exclusive or Modified) states. That is why even if the L1 wrote back the data to the L2 and changes to the exclusive state, the directory does not change and future requests still need to be sent to the L1 just in case it internally changed to modified without letting the directory know.

If another processor or element in system 1 wants data from that cache line, the CM 3 may use directory 9 to determine whether the L2 cache has a current copy of the cache line. If the L2 did, the CM 3 directly forwards the data from the L2. However, in this example, the L2 cache does not have a current copy, so CM 3 uses its directory 9 to determine that CPU 1 has that cache line and requests that CPU 1 forward CM 3 a copy of that modified cache line. Depending on the type of request CM 3 received for that cache line and the cache line's state, CM 3 may also update or request that CPU 1 update the corresponding L2 cache line. Those of ordinary skill in the art will appreciate that the CM request to CPU 1 for a cache line is an intervention request.

There are different kinds of reads that trigger the intervention (or snoop) request. One kind of read requests ownership of the cache line. Such a read could be generated by another processor, which would generate a read requesting ownership if the processor intended to modify the data, or more generally, if that processor desires to cache the data. The processor responding to the read request (and also the directory in the CM) will change the status of the cache line to either the Shared state or to the Exclusive/owned state, where the Exclusive/owned state is held by the requesting processor (depending on the particular coherency protocol used).

As discussed earlier, another kind of data usage is when a system component wants to sample the data once, and does not need to modify or reuse the data. For example, I/O device 7 may be retrieving elements of a packet from main memory 5 for transmission where each data element is simply read once and is discarded after transmission. However, some data of this packet may be cached in a cache line of CPU 0's L1 cache. In this situation, CPU 0 would receive a read discard command that lets CM 3 know that it may only provide the data being read and does not need to have the corresponding cache line written back to the L2 cache. Additionally, CPU 0 that modified its L1 cache line may modify that L1 cache line again because the I/O device 7 does not request ownership of that cache line and CPU 0 servicing the request may retain exclusive/modified ownership of the cache line.

Such an approach can work in some situations, but in some circumstances may cause problems. In particular, some cache and bus protocols may provide that control information for a particular transaction leads (arrives ahead of) data for the transaction by some number of clocks. Some implementations may not guarantee that such data will be available within a particular timeframe (e.g., there may be a variable number of clocks between control information and data, depending on system state).

For example, CPU 1 of FIG. 1 may request ownership of a cache line from the L1 cache of CPU 0. CM 3 may grant ownership to CPU 1 and update directory 9 with control information indicating that the L1 cache of CPU 1 owns the latest copy of this cache line. However, the latest data representing this cache line may not have been received from the L1 of CPU 0 because data traveling on data busses may lag control line data. If, during this period, I/O device 7 requests data at a memory address within the cache line requested by CPU 1, CM 3 will make an intervention request of requesting of CPU 1 since it is the owner of the cache line (and may, in fact, have a pending write to the cache line). It is desired to preserve ordering in the requesting/forwarding of the data. However, since requesting CPU 1's L1 cache does not have the data, CPU 1 cannot respond to the intervention request and must temporarily suspend the intervention request.

If there is another request for the same cache line when I/O device 7 requests data from the next address of the same cache line before CPU 1 has the updated data from CPU 0, then CM 3 will need to send another intervention request. These multiple intervention requests may build up in a queue that stores the pending intervention requests, and could cause an undesired overrun. The queue between CPU 1 and CM 3 should not be back pressured, because transaction ordering is desired. In one implementation, this intervention queue in CM 3 cannot refuse an intervention request.

Even when CPU 1 has the latest data in its L1 cache, it may still have to respond to several back-to-back read discard commands from I/O device 7 when the I/O device 7 is reading a block of data with sequential addresses. This means CPU 1 must spend time providing data for numerous read discard commands rather than performing other useful work such as executing instructions for one or more programs. In one configuration, CPU 1 will respond to the first read discard instruction and write-back a copy of the corresponding L1 cache line to the L2 cache and the CM 3 will update directory 5 to indicate this cache line is in the Shared state instead of indicating it is in the Modified state as was done in the prior art. Now, as long as CPU 1 does not again modify this cache line, CPU 1 has a local copy in its L1 cache for its own use, and there is an identical copy in the L2 cache that the CM 3 may use to respond to future read discards to that cache line. Thus, when receiving future read discards to the same cache line, CM 3 may now retrieve data from the L2 without interrupting CPU 1, allowing CPU 1 to be free to perform other useful work.

Changing the cache line's state from “Modified” to “Shared” in directory 9 should not cause any degradation in performance because now both the L1 and L2 caches have a copy. Though this behavior is similar to I/O device 7 device issuing a read shared command, the difference is in the directory tracking. Directory 9 of the CM 3 will assume that a requestor issuing a read shared command will cache the line and may have to receive invalidate type snoops at a later point in time when the line is lost. Directory 9 will assume that a requestor that issues a read discard command will not cache the line and does not have to be sent snoops for that line

Another scenario occurs in system 1 of FIG. 1 may occur when either CPU 0 or 1 executes a memory copy (Memcpy) routine/loop that by issuing load commands to an LSU that subsequently may issue read discard commands. A Memcpy routine/loop is used to copy a block of data from memory and saving it somewhere else or possibly transmitting that data. If the L1 cache of CPU 0 contained a large portion of modified data being copied with a Memcpy routine, then copying this large amount of data may pollute the L1 cache. This pollution may happen because the CPU doing the memcpy will thrash its cache. The cache data gets replaced with data being copied which usually will not get used again. Caching the data being copied and that does not get referenced again causes useful data that was previously in the cache to get thrown away. If the data being copied is larger than the size of the cache also causes some of the data being copied also to get evicted which results in power being wasted. In general, Memcpy reads and then writes data in a loop. The read part of the loop brings data in to the L1 cache. The write portions also brings a corresponding line in to the L1 cache if the cache is a write back cache. As the loop continues, additional lines get brought in to the cache and depending on the size of the memcpy loop, the entire cache may get filled with memcpy data. However, the read data that is brought in to the cache does not get used again after its instance of the loop. The entire cache may get replaced even though none of this data get reused and it has replaced previous data that has a higher chance of getting reused. In essence, a memcpy command reads and then writes data in a loop. The read part of the loop brings data in to the L1 cache. The write also brings that corresponding line in to the L1 cache if the cache is a writeback cache. As the loop continues, additional lines get brought in to the cache and depending on the size of the memcpy loop, the entire cache may get filled with memcpy data. However, the read data that is brought in to the cache does not get used again after its instance of the loop is performed. The entire cache may get replaced even though none of this data get reused and it has replaced previous data that has a higher chance of getting reused.

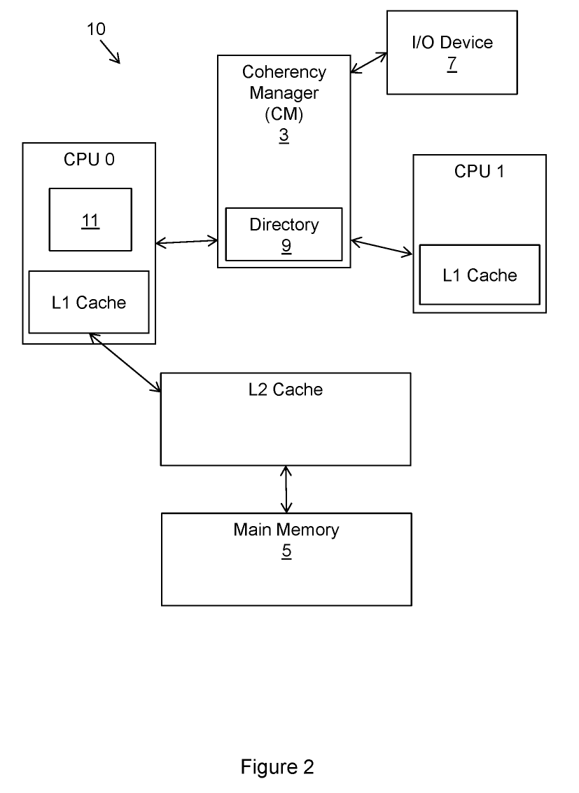

FIG. 2 illustrates an example system 10 that is similar to example system 1 of FIG. 1 and that reduces L1 cache pollution due to Memcpy routines. Similar to system 1, system 10 has a CPU 0 and CPU 1 each with a private non-shared L1 cache, a CM 3 with a directory 9, an I/O device 7, an L2 cache, and a main memory 5. In some configurations, CPU 0 further contains a block read detection logic 11 that may be used to detect whether CPU 0 is processing read shared commands associated corresponding to reading a block of memory or to a Memcpy routine and then take actions to reduce pollution of the L1 cache.

“Logic”, as used herein, includes but is not limited to hardware, firmware, software, and/or combinations of each to perform a function(s) or an action(s), and/or, to cause a function or action from another logic, method, and/or system. For example, based on a desired application or need, logic may include a software-controlled microprocessor, discrete logic such as an application-specific integrated circuit (ASIC), a programmed logic device, a memory device containing instructions or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

In some configurations, the block read detection logic 11 is configured to monitor read shared commands that CPU 0 is processing and predict that a Memcpy routine is being processed. In one embodiment, CPU 0 keeps track of the program counter (PC) of the read/load instructions and detects that CPU 0 is seeing/detecting the same PC multiple times. For example, if CPU 0 detects a threshold number of the same PC within a curtain time window or a curtain number of clocks, CPU 0 will then issue a read discard command for the rest of the current cache line being accessed and/or the next cache line. A read discard command does not fill dated into the CPU's L1 cache so there is no pollution of the L1 cache of CPU 0. Also, a read discard command causes an entire L1 cache line to be read so that a single read discard provides data to satisfy/process multiple loads/reads for an entire cache line. In other configurations, block read detection logic 11 of CPU 0 may be able to monitor addresses being accessed in its L1 cache. If block read detection logic 11 detects a sequential increasing of addresses being accessed, then CPU 0 may issue a read discard command for the rest of the current cache line being accessed and/or the next cache line. In some embodiments, CPU 0 may decide to avoid issuing extra read discard commands for that cache line and service all loads with the data returned from the first read discard.

In another configuration, the Memcpy routine may be implemented using load instruction of a special format that causes CPU 0 to recognize those instructions are processing a Memcpy loop. For example, particular flag(s) (e.g., bit[s]) may be set in an existing instruction to indicate to CPU 0 that the instruction is associated with a Memcpy loop. When block read detection logic 11 detects an instruction with a particular format or flag bits that is/are used to process a Memcpy loop, then CPU 0 may issue a read discard command for the rest of the current cache line being accessed and/or the next cache line in the sequence of the Memcpy loop to prevent the pollution of its L1 cache.

Example methods may be better appreciated with reference to flow diagrams. While for purposes of simplicity, explanation of the illustrated methodologies are shown and described as a series of blocks. It is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

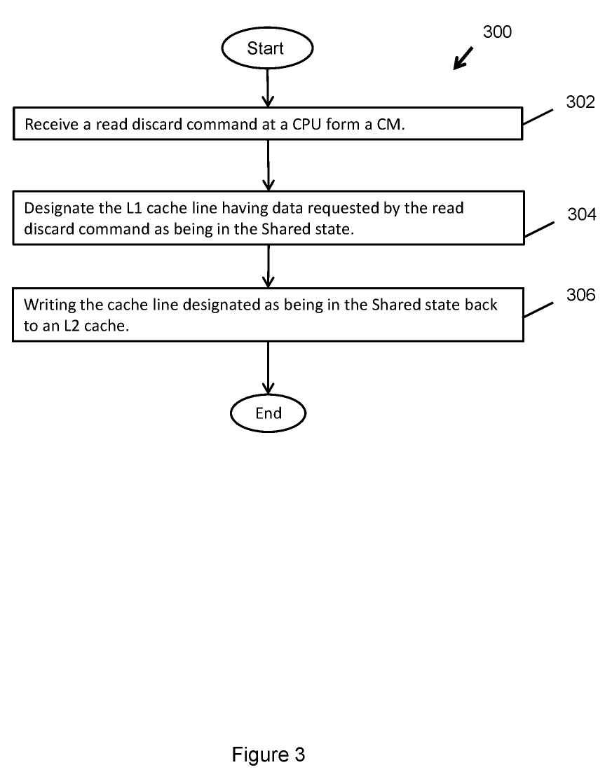

FIG. 3 illustrates a method 300 of a CPU detecting a device is reading its private L1 cache using read discard commands and moving that cache line to a Shared state. As discussed above, an I/O device or another device may at times request blocks of data using read discard commands when the device has no need to cache the data. A CPU, that may be part of a shared memory system, receives a read discard command at 302 from a CM. An L1 cache line having data requested by the read discard command is marked as being in the Shared state at 304 and is also written back to an L2 cache at 306. As discussed above, the CPU is now free to perform other useful tasks without now needing to respond to future read discard commands to that same cache line until the CPU again modifies the cache line. In some configurations, method 300 may make a determination as to if the CPU desires to not write-back the cache line and keep responding to read discard commands with the cache line in the Modified state. If the CPU does not want to respond to possible multiple read discard commands to a cache line, then it has that line placed in the Shared state, otherwise, it keeps the line in the Modified state.

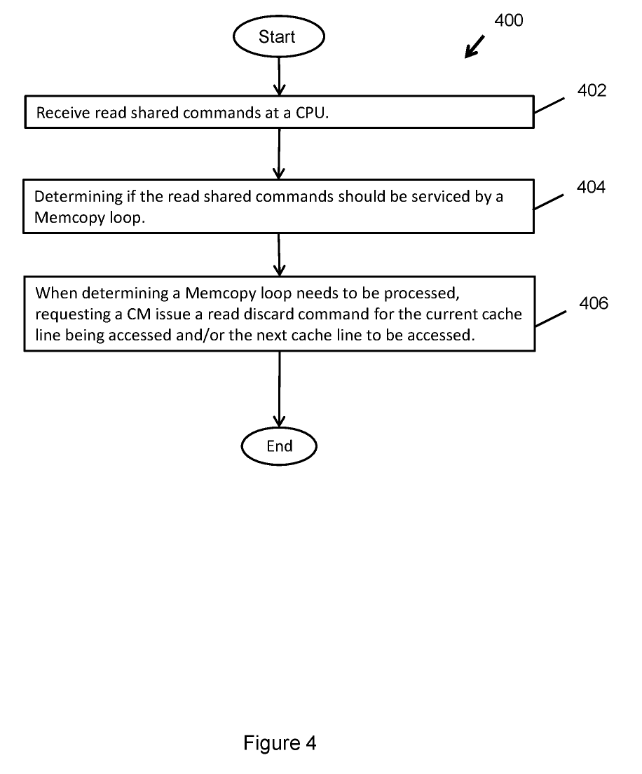

FIG. 4 illustrates an example configuration of a method 400 of reducing the pollution in an L1 cache when a CPU is executing a Memcpy routine. Method 400 begins at 402 by receiving read shared commands at a CPU at 402 where the read shared commands request data in a cache line of a private cache of the CPU. A determination is made at 404 by a CPU if the read shared commands may be serviced by a Memcpy loop or another block memory read. As discussed above, this determination may be made with block read detection logic that detects that a block of data is being read. Alternatively, a special format of the load instruction may be used to indicate to the CPU that it is may more efficient processes memory access commands with a Memcpy loop. For example, one or more flag bit(s) may be set in a load instruction that the CPU may detect as indicating the instruction corresponds to a Memcpy loop. When a Memcpy loop or another block of memory is being read, the CPU requests a CM issue a read discard command at 406 for the rest of the current cache line being accessed to prevent the pollution of the L1 cache. In some configurations, method 400 may also request the CM issue a read discard command for the next cache line in the sequence of the Memcpy loop.

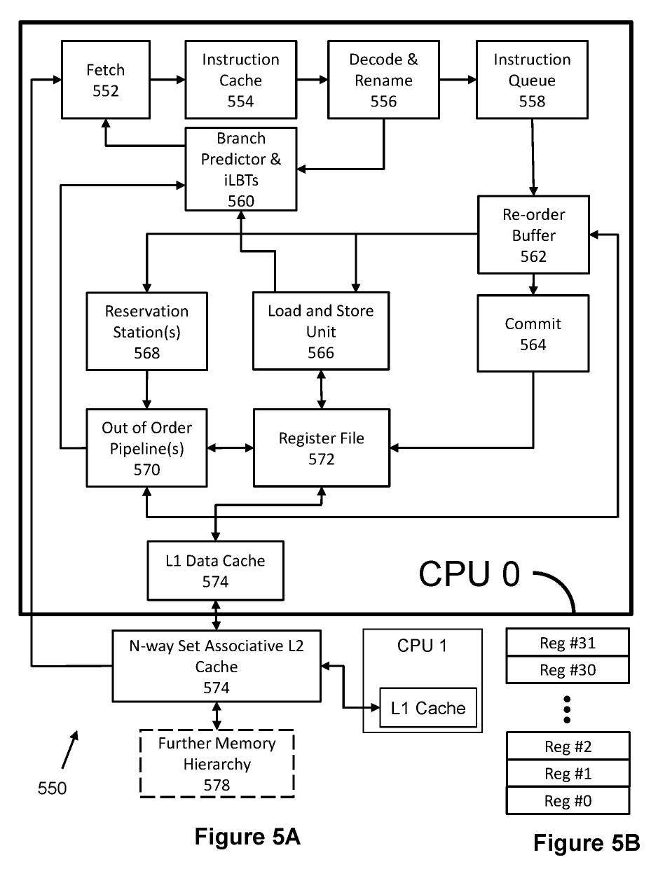

FIGS. 5A and 5B present an example block diagram of a multiprocessor system 550 that includes two processors (CPU 0 and CPU 1) that can implement the disclosure. As illustrated, CPU 0 and CPU 1 each have their own L1 cache but share the rest of a memory system that includes an L2 cache 574 and further memory hierarchy 578. In some configurations, a CM (e.g., memory management unit) with a directory of the state of each cache line is connected to CPU 0 and CPU 1.

The fetch logic 552 pre-fetches software instructions from memory that CPU 0 will execute. These pre-fetched instructions are placed in an instruction cache 554. These instructions are later removed from the instruction cache 554 by the decode and rename logic 556 and decoded into instructions that CPU 0 can process. These instructions are also renamed and placed in the instruction queue 558. The decoder and rename logic 556 also provides information associated with branch instructions to the branch predictor and Instruction Translation Lookaside Buffers (ITLBs) 560. The branch predictor and ILTBs 560 predict branches and provides this branch prediction information to the fetch logic 552 so instructions of predicted branches are fetched.

A re-order buffer 562 stores results of speculatively completed instructions that may not be ready to retire in programing order. The re-order buffer 562 may also be used to unroll miss-predicted branches. The reservation station(s) 568 provide(s) a location to which instructions can write their results without requiring a register to become available. The reservation station(s) 568 also provide for register renaming and dynamic instruction rescheduling. The commit unit 564 determines when instruction data values are ready to be committed/loaded into one or more registers in the register file 572. The load and store unit 566 monitors load and store instructions to be sure accesses to and from memory follows sequential program order, even though the processor 550 is speculatively executing instructions out of order. For example, the load and store unit 566 will not allow a load to load data from a memory location that a pending older store instruction has not yet written.

Instructions are executed in one or more out-of-order pipeline(s) 570 that are not required to execute instructions in programming order. In general, instructions eventually write their results to the register file 572. FIG. 5B illustrates an example register file with 32 registers Reg #0 through Reg #31. Depending on the instruction, data results from the register file 572 may eventually be written into one or more level one (L1) data cache(s) 574 and an N-way set associative level two (L2) cache 576 before reaching a further memory hierarchy 578.

Modern general purpose processors regularly require in excess of two billion transistors to be implemented, while graphics processing units may have in excess of five billion transistors. Such transistor counts are likely to increase. Such processors have used these transistors to implement increasingly complex operation reordering, prediction, more parallelism, larger memories (including more and bigger caches) and so on. As such, it becomes necessary to be able to describe or discuss technical subject matter concerning such processors, whether general purpose or application specific, at a level of detail appropriate to the technology being addressed. In general, a hierarchy of concepts is applied to allow those of ordinary skill to focus on details of the matter being addressed.

For example, high-level features, such as what instructions a processor supports conveys architectural-level detail. When describing high-level technology, such as a programming model, such a level of abstraction is appropriate. Microarchitecture detail describes high-level detail concerning an implementation of architecture (even as the same microarchitecture may be able to execute different ISAs). Yet, microarchitecture detail typically describes different functional units and their interrelationship, such as how and when data moves among these different functional units. As such, referencing these units by their functionality is also an appropriate level of abstraction, rather than addressing implementations of these functional units, since each of these functional units may themselves comprise hundreds of thousands or millions of gates. When addressing some particular feature of these functional units, it may be appropriate to identify substituent functions of these units, and abstract those, while addressing in more detail the relevant part of that functional unit.

Eventually, a precise logical arrangement of the gates and interconnect (a netlist) implementing these functional units (in the context of the entire processor) can be specified. However, how such logical arrangement is physically realized in a particular chip (how that logic and interconnect is laid out in a particular design) still may differ in different process technology and for a variety of other reasons. Many of the details concerning producing netlists for functional units as well as actual layout are determined using design automation, proceeding from a high-level logical description of the logic to be implemented (e.g., a “hardware description language”).

The term “circuitry” does not imply a single electrically connected set of circuits. Circuitry may be fixed function, configurable, or programmable. In general, circuitry implementing a functional unit is more likely to be configurable, or may be more configurable, than circuitry implementing a specific portion of a functional unit. For example, an Arithmetic Logic Unit (ALU) of a processor may reuse the same portion of circuitry differently when performing different arithmetic or logic operations. As such, that portion of circuitry is effectively circuitry or part of circuitry for each different operation, when configured to perform or otherwise interconnected to perform each different operation. Such configuration may come from or be based on instructions, or microcode, for example.

In all these cases, describing portions of a processor in terms of its functionality conveys structure to a person of ordinary skill in the art. In the context of this disclosure, the term “unit” refers, in some implementations, to a class or group of circuitry that implements the function or functions attributed to that unit. Such circuitry may implement additional functions, and so identification of circuitry performing one function does not mean that the same circuitry, or a portion thereof, cannot also perform other functions. In some circumstances, the functional unit may be identified, and then functional description of circuitry that performs a certain feature differently, or implements a new feature, may be described. For example, a “decode unit” refers to circuitry implementing decoding of processor instructions. The description explicates that in some aspects such decode unit, and hence circuitry implementing such decode unit, supports decoding of specified instruction types. Decoding of instructions differs across different architectures and microarchitectures, and the term makes no exclusion thereof, except for the explicit requirements of the claims. For example, different microarchitectures may implement instruction decoding and instruction scheduling somewhat differently, in accordance with design goals of that implementation. Similarly, there are situations in which structures have taken their names from the functions that they perform. For example, a “decoder” of program instructions that behaves in a prescribed manner, describes structure supporting that behavior. In some cases, the structure may have permanent physical differences or adaptations from decoders that do not support such behavior. However, such structure also may be produced by a temporary adaptation or configuration, such as one caused under program control, microcode, or other source of configuration.

Different approaches to design of circuitry exist. For example, circuitry may be synchronous or asynchronous with respect to a clock. Circuitry may be designed to be static or be dynamic. Different circuit design philosophies may be used to implement different functional units or parts thereof. Absent some context-specific basis, “circuitry” encompasses all such design approaches.

Although circuitry or functional units described herein may be most frequently implemented by electrical circuitry, and more particularly by circuitry that primarily relies on a transistor implemented in a semiconductor as a primary switch element, this term is to be understood in relation to the technology being disclosed. For example, different physical processes may be used in circuitry-implementing aspects of the disclosure, such as optical, nanotubes, micro-electrical mechanical elements, quantum switches or memory storage, magneto resistive logic elements, and so on. Although a choice of technology used to construct circuitry or functional units according to the technology may change over time, this choice is an implementation decision to be made in accordance with the then-current state of technology. This is exemplified by the transitions from using vacuum tubes as switching elements to using circuits with discrete transistors, to using integrated circuits, and advances in memory technologies, in that while there were many inventions in each of these areas, these inventions did not necessarily fundamentally change how computers fundamentally worked. For example, the use of stored programs having a sequence of instructions selected from an instruction set architecture was an important change from a computer that required physical rewiring to change the program, but subsequently, many advances were made to various functional units within such a stored-program computer.

Functional modules may be composed of circuitry where such circuitry may be a fixed function, configurable under program control or under other configuration information, or some combination thereof. Functional modules themselves thus may be described by the functions that they perform to helpfully abstract how some of the constituent portions of such functions may be implemented.

In some situations, circuitry and functional modules may be described partially in functional terms and partially in structural terms. In some situations, the structural portion of such a description may be described in terms of a configuration applied to circuitry or to functional modules, or both.

Although some subject matter may have been described in language specific to examples of structural features and/or method steps, it is to be understood that the subject matter defined in the appended claims is not necessarily limited to these described features or acts. For example, a given structural feature may be subsumed within another structural element, or such feature may be split among or distributed to distinct components. Similarly, an example portion of a process may be achieved as a byproduct or concurrently with performance of another act or process, or may be performed as multiple, separate acts in some implementations. As such, implementations according to this disclosure are not limited to those that have a 1:1 correspondence to the examples depicted and/or described.

Above, various examples of computing hardware and/or software programming were explained, as well as examples of how such hardware/software can intercommunicate. These examples of hardware or hardware configured with software and such communication interfaces provide means for accomplishing the functions attributed to each of them. For example, a means for performing implementations of software processes described herein includes machine-executable code used to configure a machine to perform such process. Some aspects of the disclosure pertain to processes carried out by limited configurability or fixed-function circuits and in such situations, means for performing such processes include one or more of special purpose and limited-programmability hardware. Such hardware can be controlled or invoked by software executing on a general purpose computer.

Implementations of the disclosure may be provided for use in embedded systems, such as televisions, appliances, vehicles, personal computers, desktop computers, laptop computers, message processors, hand-held devices, multi-processor systems, microprocessor-based or programmable consumer electronics, game consoles, network PCs, minicomputers, mainframe computers, mobile telephones, PDAs, tablets, and the like.

In addition to hardware embodiments (e.g., within or coupled to a Central Processing Unit (“CPU”), microprocessor, microcontroller, digital signal processor, processor core, System on Chip (“SOC”), or any other programmable or electronic device), implementations may also be embodied in software (e.g., computer-readable code, program code, instructions and/or data disposed in any form, such as source, object or machine language) disposed, for example, in a computer usable (e.g., readable) medium configured to store the software. Such software can enable, for example, the function, fabrication, modeling, simulation, description, and/or testing of the apparatus and methods described herein. For example, this can be accomplished through the use of general programming languages (e.g., C, C++), GDSII databases, hardware description languages (HDL) including Verilog HDL, VHDL, SystemC Register Transfer Level (RTL), and so on, or other available programs, databases, and/or circuit (i.e., schematic) capture tools. Embodiments can be disposed in computer usable medium including non-transitory memories such as memories using semiconductor, magnetic disk, optical disk, ferrous, resistive memory, and so on.

As specific examples, it is understood that implementations of disclosed apparatuses and methods may be implemented in a semiconductor intellectual property core, such as a microprocessor core, or a portion thereof, embodied in a Hardware Description Language (HDL), that can be used to produce a specific integrated circuit implementation. A computer readable medium may embody or store such description language data, and thus constitute an article of manufacture. A non-transitory machine readable medium is an example of computer-readable media. Examples of other embodiments include computer readable media storing Register Transfer Language (RTL) description that may be adapted for use in a specific architecture or microarchitecture implementation. Additionally, the apparatus and methods described herein may be embodied as a combination of hardware and software that configures or programs hardware.

Also, in some cases, terminology has been used herein because it is considered to more reasonably convey salient points to a person of ordinary skill, but such terminology should not be considered to imply a limit as to a range of implementations encompassed by disclosed examples and other aspects. A number of examples have been illustrated and described in the preceding disclosure. By necessity, not every example can illustrate every aspect, and the examples do not illustrate exclusive compositions of such aspects. Instead, aspects illustrated and described with respect to one figure or example can be used or combined with aspects illustrated and described with respect to other figures. As such, a person of ordinary skill would understand from these disclosures that the above disclosure is not limiting as to constituency of embodiments according to the claims, and rather the scope of the claims define the breadth and scope of inventive embodiments herein. The summary and abstract sections may set forth one or more but not all exemplary embodiments and aspects of the invention within the scope of the claims.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

Moreover, the description and illustration of the invention is an example and the invention is not limited to the exact details shown or described. References to “the preferred embodiment”, “an embodiment”, “one example”, “an example” and so on, indicate that the embodiment(s) or example(s) so described may include a particular feature, structure, characteristic, property, element, or limitation, but that not every embodiment or example necessarily includes that particular feature, structure, characteristic, property, element, or limitation.

What is claimed is:

1. A multiprocessor system comprising:
a first CPU with a private level 1 (L1) cache;
a second CPU with a private L1 cache;
a level 2 (L2) cache shared between the first CPU and the second CPU;
a memory coherency manager (CM);
an input/output (I/O) device;
wherein the second CPU is configured to request ownership of a cache line in the L1 cache of the first CPU that is in a Modified state, and wherein the second CPU is configured to request the CM update the cache line from a Modified state to a Shared state upon receiving a read discard command from the I/O device.

2. The multiprocessor system of claim 1 wherein before the second CPU has an updated copy of the cache line from the first CPU the CM is configured to send an intervention request to the second CPU upon receiving the read discard request from the I/O device.

3. The multiprocessor system of claim 1 wherein the L1 cache of the first CPU and the L1 cache of the second CPU are write-back caches.

4. The multiprocessor system of claim 1 wherein the first CPU is configured to write the cache line to the L2 cache before the cache line is updated by the CM from the Modified state to the Shared state.

5. The multiprocessor system of claim 1 wherein the CM manages cache lines based on the Modified, Exclusive, Shared, and Invalid (MESI) protocol that indicates whether cache lines are in a Modified state, an Exclusive state, a Shared state, or an Invalid state.

6. The multiprocessor system of claim 1 wherein the CM further comprises:
a directory, wherein the CM stores in the directory whether cache lines in the L1 cache of the first CPU and the L1 cache of the second CPU are in the Shared state or the Modified state.

7. The multiprocessor system of claim 1 wherein the L1 cache of the first CPU and the L1 cache of the second CPU are N-way set associative caches where N is an integer.

8. The multiprocessor system of claim 1 further comprising:
a shared main memory connected to the L2 cache.

9. The multiprocessor system of claim 1 wherein the read discard command is a load request of a word of data that is four bytes of data.

10. The multiprocessor system of claim 8 wherein the cache line further comprises:
at least four words of data.

11. The multiprocessor system of claim 1 is a system implemented in single semiconductor chip.

12. A method comprising:
receiving a read discard command in a CPU that requests a load of data contained in a cache line of an L1 cache privately controlled by the CPU, wherein the cache line is in a Modified state when the read discard command is received;
changing the cache line from the Modified state to a Shared state after receiving the read discard command; and
writing the cache line back to an L2 cache.

13. The method of claim 11 further comprising:
receiving the read discard command from a coherency manager (CM) managing a memory system shared by the CPU and at least one other CPU, wherein the memory system includes the L2 cache.

14. The method of claim 11 further comprising:
determining if it is desirable to change the cache line from the Modified state to the Shared state, and only changing the cache line from the Modified state to a Shared state when it is desirable to change the cache line from the Modified state to the Shared state.

15. A multiprocessor processor system comprising:
a first CPU with a private L1 cache;
a second CPU with a private L1 cache;
a L2 cache shared between the first CPU and the second CPU;
a CM tracking states of cache lines in the L2;
block read detection logic in the first CPU configured to detect that read shared instructions sent to the first CPU by the CM are performing a read of a block of data at least partially contained in a cache line of the L1 cache of the first CPU, wherein the block of data is stored at sequential addresses of memory, and wherein when the block read detection logic determines a block of data is being read the first CPU is configured to request the CM send the first CPU one or more read discard commands to read a remaining portion of the block of data.

16. The multiprocessor processor system of claim 15 wherein the read shared instructions further comprises:
read shared instructions of a format that indicates the read shared instructions are performing a read of the block of data.

17. The multiprocessor processor system of claim 16 wherein the format further comprises:
one more bits indicating a read shared instruction performing a read of the block of data, and wherein the block read detection logic if configured to detect the one or more bits.

18. The multiprocessor processor system of claim 15 wherein the block read detection logic is configured to track at least one of the group of: a program counter (PC) and load addresses and to detect the read of the block of data base on a sequence of values of at least one of the group of: the PC and the load addresses.

19. The multiprocessor processor system of claim 15 further comprising:
a memory copy (Memcpy) routine performing the read of a block of data.

20. The multiprocessor processor system of claim 15 further comprising:
an I/O device connected to the CM and configured to generate the read shared instructions.
